(19) United States
(12) Patent Application Publication
(10) Pub. No.: US 2024/0275196 A1
(43) Pub. Date: Aug. 15, 2024

(54) BATTERY DISCHARGE FEATURE

(71) Applicant: Caterpillar Paving Products Inc., Brooklyn Park, MN (US)

(72) Inventor: Nicholas A. Oetken, Brooklyn Park, MN (US)

(73) Assignee: Caterpillar Paving Products Inc., Brooklyn Park, MN (US)

(21) Appl. No.: 18/109,067

(22) Filed: Feb. 13, 2023

(51) Int. Cl. H02J 7/00; H01M 10/44

(52) U.S. Cl. CPC H02J 7/0063; H01M 10/441; H02J 7/0013

(57) ABSTRACT

An example energy system for a work machine includes battery cells connected to form a battery system. The system can further include a load bus to distribute energy from the battery system to a component of the work machine. The system can include a battery discharge controller coupled between the battery system and the load bus. The battery discharge controller can control the load bus to discharge the battery cells by providing power to at least one component of the plurality of components of the work machine.

### TECHNICAL FIELD

This document relates to energy management on work machines and in particular to techniques of safely drawing down power of the energy source of the work machines.

### BACKGROUND

Powering a large electric-drive moving work machine (e.g., a wheel loader) requires a mobile electric energy source that can provide current of hundreds to thousands of Amperes (A) at hundreds to thousands of volts (V). This mobile energy source can include multiple large capacity battery cells connected in parallel as battery strings that provide the sustained energy power needed by the work machine. High-capacity cables connect to the energy source and route the electric power between various compartments of the work machine. Because the large-capacity energy source includes batteries, the energy source does not shut off and its electric potential remains available. Therefore, electric work machines need a safe and reliable technique to draw down the charge of the large-capacity energy source to allow for safe servicing of the work machines.

U.S. Pat. No. 9,614,383 discusses a system for providing energy management and maintenance of a high energy battery pack having a self-discharger to discharge energy from the battery pack.

### SUMMARY OF THE INVENTION

Large moving work machines use a large capacity energy source that sources high voltage electrical energy to the work machine. The large capacity energy sources can be based on large capacity batteries that do not shut off. Equipment can be damaged if the large capacity energy source is not disabled safely when performing maintenance on the work machine. Also, maintenance of work machines poses a threat of injury to workers from the high voltages and currents of the large capacity energy source.

An example work machine can include battery cells connected to form a battery system. The work machine can include a load bus to distribute energy from the battery system to components of the work machine. The work machine can include a battery discharge controller coupled between the battery system and the load bus. The battery discharge controller can control the load bus to discharge the battery cells by providing power from the battery system to at least one component of the work machine. The work machine can include a user input device to receiver user input to initiate battery discharge.

An example energy system can include battery cells connected to form a battery system. The energy system can include a load bus to distribute energy from the battery system to components of a work machine. The energy system can include a battery discharge controller coupled between the battery system and the load bus. The battery discharge controller can control the load bus to discharge the battery cells by providing power from the battery system to at least one component of the work machine.

A method for managing battery discharge on a work machine can include receiving a user input requesting battery discharge of a battery system of the work machine. The method can include, responsive to receiving the user input, establishing electrical communication between the battery system and at least one machine component of the work machine. The method can include providing at least one electrical discharge path between the battery system and the at least one machine component. The method can include detecting charge level of the battery system while discharging the battery system on the electrical discharge path. The method can include terminating discharging upon detection that the charge level is below a threshold.

### BRIEF DESCRIPTION OF THE DRAWINGS

FIG. 1 is an elevation view depicting an example work machine in accordance with this disclosure.

FIG. 2 is a schematic of an energy source for a work machine having battery control circuitry to implement controlled battery discharge in accordance with this disclosure.

FIG. 3 is a flow chart of a method for controlled battery discharge in accordance with this disclosure.

### DETAILED DESCRIPTION

Examples according to this disclosure are directed to methods and devices for managing high voltage electrical energy provided to electrical circuits and electrical motors of a work machine. Techniques for drawing down the power in an energy system of a mobile work machine are described.

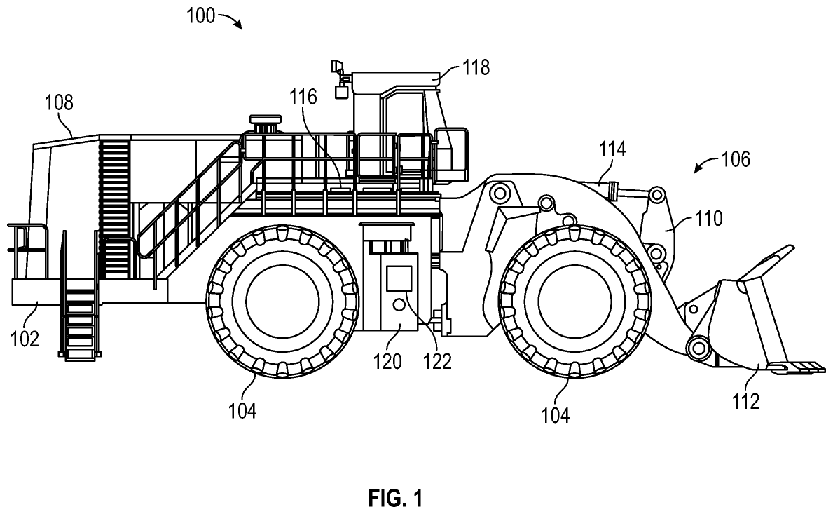

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more or fewer than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118 or a remote operator. The operator can, for example, drive machine 100 to and from various locations on a work site and can also pick up and deposit loads of material using bucket 112 of implement 106. Autonomous operation is also possible. As an example, machine 100 can be used to excavate a portion of a work site by actuating cylinders 114 to articulate bucket 112 via linkage 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the machine 100. Battery system 120 can include discharge control circuitry 122 for implementing operations for controlled battery discharge as described herein.

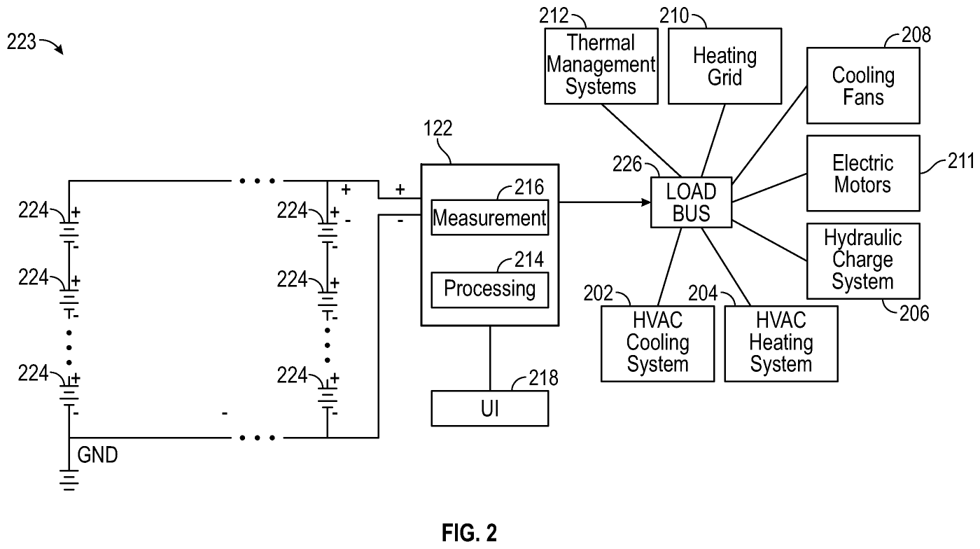

The battery system 120 can include multiple small battery cells arranged or combined into a large battery pack. For example, cells can be 3.2-3.7 volts and 2-304 Ah. The battery back can include in total 750 Volts. 80 Amp-hour battery, or 60 kilowatt-hours), to provide a high-capacity electrical energy source. The battery cells 224 (FIG. 2) may be included in one battery pack or multiple battery packs connected in parallel in the battery system. In some examples, the battery system includes fuel cells that provide a high-capacity electrical energy source. The machine 100 may include multiple battery systems.

A battery system 120 may be used to provide a high voltage, high direct current (DC) electrical energy source (e.g., 700V-3000V and 300A-1000+A). The output of the battery system may be provided to a converter or inverter to produce a high voltage, high alternating current (AC) electrical energy source. The energy source or sources provide electrical power to electrical motors, pumps, circuits, etc., of the machine 100 including some components described herein with respect to FIG. 2. The battery system 120 can include discharge control circuitry 122 to initiate controlled battery discharge operations as described herein. The discharge control circuitry 122 can comprise a service tool or a connector provided on the work machine 100 to connect to the battery system 120.

Vehicles hold large amounts of potential energy in energy sources, even after the vehicles stop operation. Such energy can complicate maintenance operations. In addition to maintenance operations the battery may be placed at a reduced state or level of charge during transportation or storage, or to lower the potential energy risk when the battery is inside of a building It can be dangerous to perform maintenance or diagnostic work on a work machine while the energy source is fully charged. In addition, some industry standards or employer standards may have an upper charge level limit above which a battery cannot be charged while maintenance work is being implemented on the work machine.

Systems and methods according to embodiments address these and other concerns by providing a battery discharge feature to bring the battery to a lower state of charge in a controlled fashion and in a safe location (e.g., in a maintenance bay or other controllable environment). The controlled battery discharge feature can utilize energy from a battery or system of batteries to provide power to one or more systems/components of the work machine 100 until a state of charge of the battery drops below a predetermined threshold (e.g., 50% charge or other value as determined according to industry standards, owner determination, mechanic determination, etc.) The controlled battery discharge feature can reduce or risk to an operator during maintenance/service operation. The threshold can be stored in memory of any computing system remote or local to the work machine or processor 214, or entered as a user preference, or programmed as a constant into the processor 214. The threshold can thereafter be retrieved from memory or programmed into the battery discharge controller.

FIG. 2 is a schematic of an energy source for a work machine having battery discharge control circuitry 122 to implement controlled battery discharge in accordance with this disclosure. The battery system 120 includes multiple battery cells 224 (e.g., from dozens to thousands of battery cells, or 16-2000 or more battery cells) connected in series and parallel to form a high pole (+) and a low pole (−) of the battery system 120. The battery cells 224 are typically relatively small battery cells arranged or combined into a large battery pack. For example, cells can be 3.2-3.7 volts and 2-304 Ah. The battery back can include in total 750 Volts, 80 Amp-hour battery, or 60 kilowatt-hours). Other battery systems can use different arrangements of battery cells, battery modules, battery strings and battery packs.

The battery system 120 provides high-voltage high-current electrical energy to a load bus 226. The load bus 226 distributes electrical power to different areas or components of the work machine 100 including, for example, heating, ventilation, and air conditioning (HVAC) cooling system 202, an HVAC heating system 204, a hydraulic charge system 206, cooling fans 208, heating grid 210, electric motor(s) 211 and thermal management system 212. Some examples may not include an HVAC heating system 204 or an HVAC cooling system 202. For example, work machines 100 that do not include an operator cab will typically not include an HVAC heating system 204 or an HVAC cooling system 202. Other systems capable of drawing electrical power can also be included, and more than one of each type of system can be included, on the work machine 100 and coupled to the load bus 226. The HVAC cooling system 202, HVAC heating system 204, hydraulic charge system 206, cooling fans 208, heating grid 210, and thermal management system 212, as well as any other electrical systems not shown, can selectively (or as a group with other components) receive power during a discharge process.

The discharge control circuitry 122 can include processor 214, switches or other circuitry to selectively connect the battery system 223 to one or more of the HVAC cooling system 202, HVAC heating system 204, hydraulic charge system 206, cooling fans 208, beating grid 210, and thermal management system 212, as well as any other electrical systems not shown. The discharge control circuitry 122 can connect different cells of a multi-cell battery system 223 to the load bus 226 or to different systems/components or groups of systems/components including the HVAC cooling system 202, HVAC heating system 204, hydraulic charge system 206, cooling fans 208, heating grid 210, and thermal management system 212, as well as any other electrical systems.

The discharge control circuitry 122 can include measurement circuitry 216 to measure charge of the battery system 223 and other parameters for measuring health of the battery system 223. The discharge control circuitry 122 can comprise a service tool connectable to the battery system 223 or the discharge control circuitry 122 can comprise buttons or switches of the work machine, e.g., behind fuse panels or incorporated in fuse boxes, etc. The discharge control circuitry 122 can include a user display or the discharge control circuitry 122 can be coupled to a user display 218 either on the work machine 100 (e.g., in operator cabin 118 (FIG. 1)) or at a remote location. The user interface 218 can display charge status of the battery system 223, diagnostics related to any electrical systems powered by the battery system 223, etc. as well as any general information related to the work machine 100. The UI 218 can receive user input (using switch, touch screen, or other mechanism) to allow a user to initiate controlled battery discharge, terminate controlled battery discharge, or perform other battery or energy-related operations. The UI 218 can allow a user to indicate a user preference for rate or speed of discharge, or a threshold charge value to which the battery system 223 should be discharged.

The discharge control circuitry 122 can control the discharge process to discharge the battery cells 224 at different speeds or rates. For example, if rapid discharge is desired, the discharge control circuitry 122 can increase the amount of current draw or provide discharge through high energy usage components through which more energy can be discharged (or discharged more rapidly), such as, for example, hydraulic charge system 206. A resistive heating grid 210 can be added to the load bus 226 to provide additional energy draw from the battery cells 224. In some examples including multiple battery packs, the multiple battery packs may be at different states of charge. However, this is not typical since the battery packs are connected together and the pack voltages (state of charge) will balance out over time. The battery management system (BMS) can work to balance cell voltages within each battery pack. If a slow discharge rate is desired, the discharge control circuitry 122 can decrease the amount of current draw or provide discharge through components through which less energy can be discharged (or discharged more slowly), such as, for example, a cooling fan.

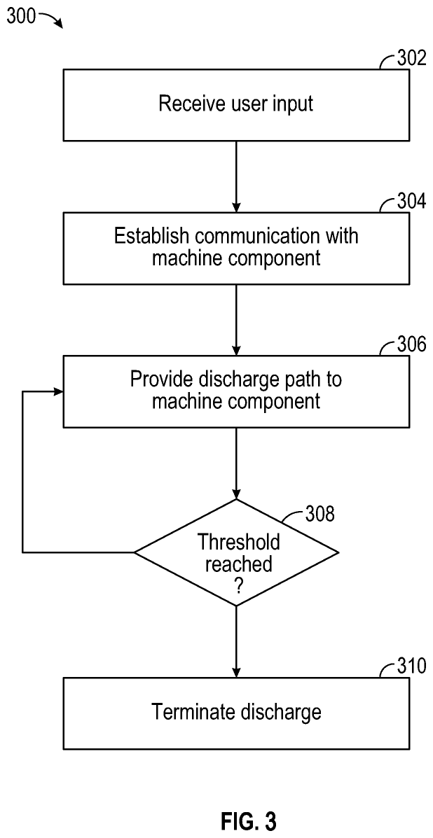

FIG. 3 is a flow chart of a method 300 for controlled battery discharge in accordance with this disclosure. The method 300 can be implemented by the discharge control circuitry 122, for example on the battery system 120 and components of the work machine 100.

The method 300 can begin with operation 302 with the discharge control circuitry 122 receiving a user input requesting battery discharge of a battery system 120 of the work machine 100. The user input can be provided through push buttons, switches, touch screens, etc., either on a service tool or the user display, or as switches on the work machine 100 itself.

The method 300 can continue with operation 304 with the discharge control circuitry 122 establishing electrical communication between the battery system 120 and at least one machine component of the work machine 100. For example, connection can be established to the HVAC cooling system 202, the HVAC heating system 204, hydraulic charge system 206, cooling fan/s 208, heating grid 210, or thermal management system/s 212 among other components. Some types of work machines may not include all of the above components, and some work machines may include other components through which battery discharge can occur.

The method 300 can continue with operation 306 with the discharge control circuitry 122 (in conjunction with the load bus 226, for example) providing at least one electrical discharge path between the battery system 120 and the at least one machine component 202, 204, 206, 208, 210, 212. At operation 308, the discharge control circuitry 122 (using, for example, measurement circuitry 216) can detect the charge level of the battery system 223 while discharging the battery system 120 on the electrical discharge path. At operation 310, if the charge level falls or declines below a preferred threshold, the discharge control circuitry 122 can terminate discharge, otherwise, the process can loop back to operation 306 and discharging can continue. Throughout method 300, the discharge control circuitry 122 can provide visual or other updates as to status and progress to a user through a user display, audio alarm, etc.

### INDUSTRIAL APPLICABILITY

In an operating example of an energy source for a mobile work machine according to this disclosure, it is desired for technicians or other maintenance workers to perform maintenance on the work machine. The high-capacity energy source can be battery-based, or fuel-cell based, and does not shut off like a combustion engine. When maintenance is to be performed on the work machine, it is desired to protect the workers from coming into contact with the high voltage and high current of the energy source. Battery control circuitry allows for connection of the battery to different systems on the work machine, and for initiation of a discharge operation to draw battery voltage or charge below a threshold.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
a plurality of battery cells connected to form a battery system;
a load bus to distribute energy from the battery system to a plurality of components of the work machine;
a battery discharge controller coupled between the battery system and the load bus, the battery discharge controller configured to control the load bus to discharge the battery cells by providing power from the battery system to at least one component of the plurality of components of the work machine; and
a user input device configured to receive user input to initiate battery discharge.

2. The work machine of claim 1, wherein the plurality of components includes an electric motor.

3. The work machine of claim 1, wherein the plurality of components includes at least one of a heating, ventilation, and air conditioning (HVAC) cooling system or an HVAC heating system.

4. The work machine of claim 3, wherein the plurality of components includes at least one of a heating grid, a cooling fan, a thermal management system, and a hydraulic charge system.

5. The work machine of claim 3, wherein the battery discharge controller is configured to provide power to a hydraulic charge system when the user input indicates preference for a rapid discharge rate.

6. The work machine of claim 3, wherein the battery discharge controller is configured to provide power to a cooling fan when the user input indicates preference for a slow discharge rate.

7. The work machine of claim 1, further comprising battery system measurement circuitry to measure at least a charge level of the battery system.

8. The work machine of claim 7, wherein the user input device is coupled to the battery system measurement circuitry and wherein the user input device includes one of a switch or a touch screen button for terminating discharge of the battery system.

9. The work machine of claim 8, wherein discharge of the battery system is terminated upon a charge level of the battery system declining to a threshold.

10. The work machine of claim 9, wherein the threshold is configurable by a user.

11. An energy system comprising:
a plurality of battery cells connected to form a battery system;
a load bus to distribute energy from the battery system to a plurality of components of a work machine; and
a battery discharge controller coupled between the battery system and the load bus, the battery discharge controller configured to control the load bus to discharge the battery cells by providing power from the battery system to at least one component of the plurality of components of the work machine.

12. The energy system of claim 11, wherein the battery discharge controller is provided in a service tool.

13. The energy system of claim 11, further comprising battery system measurement circuitry to measure charge levels of the battery system.

14. The energy system of claim 11, wherein the battery discharge controller is configured to control a speed of discharge.

15. The energy system of claim 14, wherein the battery discharge controller is configured to increase speed of discharge by discharging the battery system through a component with high energy usage.

16. The energy system of claim 15, wherein the component with high energy usage includes a hydraulic charge system.

17. The energy system of claim 14, wherein the speed of discharge is received through a user interface indicating a user preference.

18. The energy system of claim 14, wherein the battery discharge controller is configured to access a preferred speed of discharge from memory.

19. The energy system of claim 11, wherein the battery discharge controller is configured to control discharge to a threshold charge level.

20. The energy system of claim 19, wherein an indication of the threshold charge level is retrieved from memory or programmed into the battery discharge controller.

21. A method for managing battery discharge on a work machine, the method comprising:
receiving a user input requesting battery discharge of a battery system of the work machine;
responsive to receiving the user input, establishing electrical communication between the battery system and at least one machine component of the work machine;
providing at least one electrical discharge path between the battery system and the at least one machine component;
detecting charge level of the battery system while discharging the battery system on the electrical discharge path; and
terminating discharging upon detection that the charge level is below a threshold.

22. The method of claim 21, wherein an indication of the threshold is received as a user input or retrieved from memory.
